(19) United States
(12) Patent Application Publication
(10) Pub. No.: US 2005/0101491 A1
(43) Pub. Date: May 12, 2005

(54) Cellulosic suspensions employing alkali formate brines as carrier liquid

(76) Inventor: Daniel P. Vollmer, Lafayette, LA (US)

Correspondence Address: John Wilson Jones;Attn: IP Docketing Clerk, Locke, Liddell & Sapp LLP, 600 Travis, Suite 3400, Houston, TX, 77002, US

(21) Appl. No.: 10/705,180

(22) Filed: Nov. 11, 2003

(51) Int. Cl. C09K 7/02

(52) U.S. Cl. 507/112

(57) ABSTRACT

A fluidized cellulosic polymer suspension of a cellulosic polymer in an alkali formate containing solution is particularly efficacious in the thickening of brines, particularly high density brines, in the recovery of oil and/or gas from a subterranean formation. The alkali formate containing solution preferably has between from about 40 to about 75 weight percent of alkali formate. Preferred as alkali formate are potassium formate, cesium formate and a mixture thereof. The true crystallization temperature (TCT) of the alkali formate solution is preferably less than or equal to 20°, more preferably less than or equal to 18° F., most preferably less than or equal to 10° F., ideally less than or equal to 0° F. The alkali formate solution serves as the carrier fluid, allowing the cellulose to be easily metered into the brine, thereby allowing hydration without the formation of fisheyes.

### FIELD OF THE INVENTION

The present invention is directed to compositions for thickening aqueous fluids, including brines, and methods of using the same, especially in oilfield operations.

### BACKGROUND OF THE INVENTION

Brines are commonly used to exploit oil and gas from such subterranean petroliferous formations as drilling, drill-in, hydraulic fracturing, work-over, packer, well treating, testing, spacer, acid stimulation, acid diverting, or hole abandonment fluids because of their wide density ranges. Brines commonly used as completion and work-over fluids are tabulated in Table I with their respective density range:

TABLE I

| Aqueous Brine | Brine Density Range, |
|---|---|
| Composition | pounds per gallon (ppg) |
| NH₄CL | 8.3-9.6 |
| KCl | 8.3-9.7 |
| KHCO₂ | 8.3-13.3 |
| NaCl | 8.3-10.0 |
| NaHCO₂ | 8.3-10.9 |
| NaBr | 8.3-12.7 |
| NaCl/NaBr | 10.0-12.7 |
| CaCl₂ | 8.3-11.6 |
| CaBr₂ | 8.3-15.3 |
| CaCl₂/CaBr₂ | 11.6-15.1 |
| CaCl₂/CaBr₂/ZnBr₂ | 15.1-19.2 |
| CaBr₂/ZnBr₂ | 14.2-19.2 |
| CsHCO₂ | 8.3-19.2 |

During completion and work-over operations, when the hydrostatic pressure of the fluid exceeds the pressure of the formation, brines tend to escape into the formation. Once they have escaped, these fluids are not capable of being utilized in any stage of the completion process. Thus, it is common to thicken a small volume of brine with a water soluble polymer (a fluid loss pill) and then pump the thickened formulation at the formation in order to alleviate fluid losses. Typical thickening polymers are cellulosic polymers, such as hydroxylethylcellulose (HEC) and carboxylmethyl hydroxylethylcellulose (CMHEC).

One of several problems may occur when attempting to thicken or viscosify such aqueous brines. One such problem is the formation of fisheyes. At low salt concentration, fisheyes occur. A fisheye, lump, or microgel, occurs when the polymer hydrates too quickly, causing a gel coating to surround the dry polymer, thereby preventing solubilization. A second problem lies in the difficulty in effectuating viscosification. At high salt concentrations, the thickening polymer is unable to dissolve to effectuate thickening of the brine. Often, the time period to viscosity the aqueous brines is overly long; in other instances, the brine fails to viscosify over prolonged times. Such problems occur in light of the amount of water within the brine. See R. F. Scheuerman, “Guidelines for HEC Polymers for Viscosifying Solids-Free Completion and Workover Brines,” Journal of Petroleum Technology, February, 1983, p. 306-314.

Methods to viscosify brines and to alleviate the formation of fisheyes by the use of water soluble polymers has been reported. For example, U.S. Pat. No. 4,330,414 discloses mixing HEC in a solvating agent comprising a water miscible polar organic liquid and dispersing the resulting mixture in a brine. This procedure thickens brines and alleviates the formation of fisheyes more rapidly as compared to a similar procedure not employing a solvating agent. Unfortunately, the method promotes bottom settling and possible hardening of the polymer. However, the inventors do teach the addition of organophilic clays to aid suspension, but clays cause formation damage when this invention is used as a fluid loss pill.

U.S. Pat. No. 5,228,909 discloses a stable HEC mixture in a 28 to 35 weight percent solution of sodium formate. While the 28 weight percent lower limitation is reported to be necessary to prevent gelling of the HEC at ambient temperature, such systems, when cooled to 35° F., evidence gelling; the gelled state remains when the system is heated to 75° F. This is unacceptable, especially when the mixture is stored in an uncontrolled climate, the typical climatic state during oil and gas recovery operations. Another problem is attributable to crystallization of the sodium formate. This occurs at near sodium formate saturation and manifests itself as a solid mass.

In D. Vollmer et al., “HEC Precipitation Solutions”, Hart's E&P, January 2000, pp. 98-100, the author discusses the precipitation of HEC from sodium, potassium and cesium formate solutions at elevated temperatures. HEC is reported as being incapable of viscosifying these formate brines at densities far from saturation at 80° F. (10.5 ppg and above for potassium formate solutions) and even further at 120° F. (10.3 ppg and above at 120° F.). The precipitates ultimately harden, thereby effecting the overall efficacy of the treatment.

A system capable of thickening brines, especially high density brines, without precipitation of the cellulosic polymer or alkali formate is therefore desired.

### SUMMARY OF THE INVENTION

A fluidized cellulosic polymer suspension of a cellulosic polymer in an alkali formate containing solution is particularly efficacious in the thickening of brines and is useful, particularly in high density brines, in the recovery of oil and/or gas from a subterranean formation.

The alkali formate containing solution preferably has between from about 40 to about 75 weight percent of alkali formate. In one embodiment, the fluidized cellulosic polymer is suspended, at 70° F., in an alkali formate solution containing 40% or more (based on the total weight of water and salt of alkali formate dissolved in water) of alkali formate. Especially preferred as alkali formate are potassium formate, cesium formate, or a mixture thereof. In one embodiment, no more than 25 weight percent of the alkali formate in the solution is sodium formate, the remainder being potassium formate, cesium formate, or a mixture thereof.

The true crystallization temperature (TCT), API Recommended Practice 13 J, Second Edition, March 1996, of the alkali formate solution is preferably less than or equal to 20°, more preferably less than or equal to 18° F., most preferably less than or equal to 10° F., ideally less than or equal to 0° F.

The cellulosic polymer is preferably either anionic or non-ionic, most preferably anionic modified or nonionic modified cellulose, including carboxymethylhydroxyethyl cellulose (CMHEC) or hydroxyethyl cellulose (HEC), as well as crosslinked HEC, such as crosslinked HEC with glycoxal.

### DETAILED DESCRIPTION OF THE PREFERRED EMBODIMENTS

The cellulosic polymer suspension of the invention is highly useful in the thickening of brines, especially high density brines, i.e., those brines having a density greater than or equal to 11.6, preferably between 11.6 and 14.2, pounds per gallon (ppg) at 70° F. The cellulosic suspension, free of fisheyes, lumps and microgels, is pourable.

The cellulosic polymer suspensions of the invention are especially useful in brines to clean the wellbore during washing, milling and reaming operations. In addition, it can be used during displacement and gravel pack operations. A major advantage of the suspensions of the invention is that they are capable of viscosifying brine fluids without the need for special rig equipment or shear devices.

The cellulosic polymer is typically either non-ionic or anionic. Preferred anionic cellulosic polymer is carboxymethylhydroxyethyl cellulose and preferred non-ionic cellulosic polymer is hydroxyethyl cellulose. The cellulosic polymer is preferably either anionic or non-ionic, most preferably anionic modified or nonionic modified cellulose, including carboxymethylhydroxyethyl cellulose (CMHEC) or hydroxyethyl cellulose (HEC), as well as crosslinked HEC, such as crosslinked HEC with glycoxal. Particularly preferred are crosslinked HECs, such as HEC 10 and HEC 10HV, products of The Dow Chemical Company, and as non-crosslinked HEC, 210 HHW, a product of Aqualon. The HEC 10HV provides a higher viscosity per pound that HEC 10. The amount of cellulosic polymer suspended in the salt solution is typically between from about 5 to about 23, preferably from about 10 to about 20, weight percent.

The salt solution, containing the alkali formate, serves as a carrier liquid for the delivery of the cellulosic polymer to the aqueous high density brine solution. Suitable alkali formates include cesium formate and potassium formate. The amount of alkali formate in the salt solution, to which is introduced the cellulosic polymer, is between from about 40 to about 75 weight percent. The greater the alkali formate in the solution, the greater the amount of cellulosic polymer may be used to fluidize the suspension. Higher amounts of cellulosic polymer, however, increase the mixing time required to thicken the high density brine.

The alkali formate may further include a mixture of one of calcium formate, cesium formate and/or potassium formate with sodium formate. For example, the fluidized cellulosic polymer may be suspended, at 70° F., in 40% or more (based on the total weight of water and salt of alkali formate dissolved in water) of alkali formate solution, wherein the alkali formate solution contains no more than 25% of sodium formate. For example, the alkali solution may contain 25% sodium formate and 15% potassium formate.

The salt solution is inherently shale inhibitive, does not require potassium chloride, can be used directly with water or brine, and, by passing the EPA Static Sheen test and Oil and Grease test, is environmentally friendly. For details describing the shale inhibitive characteristics of formates, refer to J. H. Hallman, et al, “Enhanced Shale Stabilization with Very Low Concentration Potassium Formate/Polymer Additives,” SPE 73731, February 2002.

The salt solution employed in the invention is characterized by a very low crystallization temperature (TCT), API 13 J. The TCT of the alkali formate solution used in the invention is preferably less than or equal to 20°, more preferably less than or equal to 18° F., most preferably less than or equal to 10° F., ideally less than or equal to 0° F. Such TCTs are dramatically lower than those which characterize a sodium formate salt solution. The TCTs for sodium formate are set forth in Table II below:

TABLE II
Crystallization Temperatures for Sodium Formate Solutions

| Density, | Specific | Wt. % | |
|---|---|---|---|
| ppg @ 70° F. | Gravity | NaHCO₂ | TCT, ° F. |
| 8.99 | 1.079 | 12.3 | 18 |
| 9.63 | 1.155 | 22.2 | 2 |
| 10.12 | 1.214 | 29.9 | 20 |
| 10.55 | 1.265 | 37.5 | 49 |
| 10.73 | 1.287 | 40.2 | 54 |
| 10.81 | 1.297 | 41.5 | 56 |
| 10.91 | 1.309 | 43.0 | 59 |

and is markedly distinct from that of potassium formate, set forth in Table III:

TABLE III
Crystallization Temperatures for Potassium Formate Solutions

| Density, | Specific | Wt. % | |
|---|---|---|---|
| ppg @ 70° F. | Gravity | KHCO₂ | TCT, ° F. |
| 9.04 | 1.084 | 15.1 | 19 |
| 10.03 | 1.205 | 32.4 | −15 |
| 10.43 | 1.251 | 38.4 | −28 |
| 10.78 | 1.293 | 44.4 | <−30 |
| 11.68 | 1.401 | 57.2 | <−30 |
| 12.18 | 1.461 | 63.5 | −36 |
| 12.50 | 1.499 | 67.5 | −12 |
| 12.98 | 1.557 | 73.5 | 9 |
| 13.17 | 1.580 | 76.0 | 28 |

In an alternative embodiment, a suspension stabilizer, such as xanthan gum, may further be incorporated in the alkali formate salt solution. Alternatively, other suspension stabilizers such as carboxymethylhydroxypropyl guar (CMPHG), carboxymethylcellulose (CMC), guar gum, and sodium alginate may further be employed. Typically, the suspension stabilizer is unnecessary because the brine is normally heavier than the polymeric suspension, therefore, settling of the cellulosic polymer is not possible. When however it is employed, the amount of stabilizer present in the alkali formate solution is typically between from about 0.03 to about 1.0 percent by weight.

The amount of cellulosic suspension introduced into the brine to increase the brine viscosity is dependent upon the composition and density of the brine, and typically requires between from about 0.5 to about 8.0, preferably between from about 1.0 to about 5 pounds of cellulosic polymer.

Further, it may be desirable to add a fluid loss pill, such as a water soluble polymer to the brine at the formation to alleviate fluid loss, particularly from completion fluids. Particularly preferred fluid loss pills, which include solids-free fluid loss pills, as well as their method of use, are disclosed in U.S. Pat. No. 6,632,779, herein incorporated by reference. The fluid loss pill should further have a density greater than the density of the brine in order that the fluid loss pill may remain in contact with the formation wall at the desired depth in the wellbore and not be displaced by the brine solution. Typically, the amount of fluid loss pill added to the brine is dependent on hydrostatic pressure, pressure, the volume of the hole to cover the perforation, formation permeability, pill viscosity at the bottom hole temperature and thermal degradation rate of the pill.

Typically, it may be desirous to change the pH of the treated brine with an acid or base. Typical acids are fumaric, hydrochloric, acetic and citric. Bases can be magnesium hydroxide, magnesium oxide, calcium hydroxide, calcium oxide, sodium hydroxide, potassium hydroxide sodium carbonate, and potassium carbonate. The desired pH is about 3 to 4 or 9-11. Typically, the acid is added in an amount between from about 0.2 to 0.5 lb/bbl for calcium brines and from about 2 to about 5 ppb for other types of brine and water. Bases are added at 0.2 to 2 pounds per barrel for all brines and water.

It may further be desired to add a crosslinker to the brine to assist in crosslinking of the functional groups of the cellulosic polymer. Preferred as crosslinkers are those that contain zirconium and titanium complexes as described in U.S. Pat. No. 4,797,216, U.S. Pat. No. 5,067,565 and U.S. Pat. No. 5,789,351. When used, the amount of crosslinking additive is preferably present in the range of from about 0.5% to in excess of 20% by weight of the cellulosic polymer. Preferably, the concentration of crosslinking agent is in the range of from about 0.7% to about 1.5% by weight of the cellulosic polymer.

The cellulosic suspension of the invention may be prepared off-site and shipped to the desired subterranean formation to be treated. Settling of the polymeric suspension during transportation is generally not possible since the formate density is greater than the density of the cellulosic polymer.

The following examples will illustrate the practice of the present invention in its preferred embodiments. Other embodiments within the scope of the claims herein will be apparent to one skilled in the art from consideration of the specification and practice of the invention as disclosed herein. It is intended that the specification, together with the example, be considered exemplary only, with the scope and spirit of the invention being indicated by the claims which follow.

### EXAMPLES

Tests were performed with two types of HEC: A HEC that has been crosslinked with glyoxal (HEC 10 obtained from The Dow Chemical Company) and a non-crosslinked HEC (obtained from Aqualon as 210 HHW). The following examples teach how to thicken brines (about 350 ml) using a cellulosic polymer suspended in an aqueous solution of alkali formate without limiting the scope of the invention. The examples illustrate thickening of brines with minimization of fisheyes by use of the cellulosic suspensions.

### Example Nos. 1-14

Inventive viscosifier compositions are prepared by mixing by weight the cellulosic polymer in an aqueous solution of sodium formate, potassium formate or cesium formate or a mixture thereof. The cellulosic polymer was HEC 10, 210 HHW or carboxymethylhydroxyethyl cellulose (CMHEC). The concentration of the alkali formate in the salt solution is above 40% by weight to maintain the suspension. Table IV shows the results of the tests.

TABLE IV

| Ex. | Cellulosic | Wt. | | |
|---|---|---|---|---|
| No. | Polymer | % | Solution | Comments |
| 1 | HEC 10 | 10 | 90% of 11.0 ppg | Thin liquid at 72° F., |
| | | | KHCO₂ | Paste at 50° F., |
| | | | | Gelled at 30° F. |
| 2 | HEC 10 | 15 | 85% 11.3 ppg | Thin liquid at 72° F., |
| | | | KHCO2 | Paste at 30° F. |
| 3 | HEC 10 | 20 | 80% of 11.8 ppg | Liquid at 72° F., |
| | | | KHCO₂ | Thin Paste at 0° F. |
| 4 | HEC 10 | 15 | 85% of 11.8 ppg | Thin liquid at 72° F., |
| | | | KHCO2 | Thick liquid at 30° F. |
| | | | | for 3 days. |
| Comp. | 210 HHW | 10 | 90% of 10.0 ppg | Gelled within 1 minute |
| Ex. 5 | | | NaHCO₂ | |
| 6 | 210 HHW | 10 | 90% of 11.5 ppg | Liquid at 72° F., |
| | | | KHCO₂ | Thick liquid at 0° F. |
| 7 | 210 HHW | 16 | 84% of 11.8 ppg | Liquid at 72° F. |
| | | | KHCO2 | and at 30° F. |
| Comp. | HHW210 | 20 | 80% of 10.9 ppg | Liquid at 72° F., |
| Ex. 8 | | | NaHCO₂ | Solid at 50° F. |
| 9 | 210 HHW | 20 | 80% of 50/50 | Liquid at 72° F., |
| | | | 10.5 ppg NaHCO₂/ | thick paste at 0° F. |
| | | | 12.0 ppg KHCO₂ | |
| Comp. | 210 HHW | 25 | 75% of 13.1 ppg | Paste at 72° F. |
| Ex. 10 | | | KHCO₂ | |
| 11 | CMHEC | 10 | 90% of 11.5 ppg | Thick Liquid at 72° F. |
| | | | KHCO₂ | |
| Comp. | HEC 10 | 10 | 90% of 11.3 ppg | Gelled within 1 minute |
| Ex. 12 | | | KC₂H₃O₂ | |
| | | | (62.5 wt %) | |
| 13 | HEC 10 | 10 | 90% of 15.6 ppg | Thick Liquid at 72° F. |
| | | | CsHCO₂ | |
| 14 | CMHEC | 14 | 86% of 12.2 ppg | Liquid at 72° F., |
| | | | KHCO₂ | Thick liquid at 0° F. |

Note that Comp. Ex. 12, having densities and salt concentration greater than Example No. 1, is not suited as a carrier liquid for HEC.

### Example No. 15

Two solutions were prepared having identical composition. One solution (Solution #1) contained 16.6 pounds per barrel (ppb) of Example No. 9 added to an 11.6 pounds per gallon (ppg) calcium chloride solution while stirring using an overhead stirrer. This solution contained 13.6 ppb of 12.0 ppg potassium formate and sodium formate solution and 3 ppb of HEC 10. The other solution (Solution #2) contained 6.8 ppb of 12.0 ppg of potassium formate solution, 6.8 ppb of 10.5 ppg sodium formate solution added to the 11.6 ppg calcium chloride and subsequently, 3 ppb of dry HEC 10. Both solutions, having identical compositions, were allowed to stir and their thickness measured using a Fann 35 rheometer (B1 bob) at intervals. Table V shows the results wherein the greater the reading from the Fann 35 rheometer, the greater the fluid's viscosity. Note that Solution #1 viscosifies within 30 minutes of stirring while Solution #2 requires an hour to achieve nearly identical viscosity.

TABLE V
Viscosification of 11.6 ppg Calcium Chloride Solution

| | Solution #1 | | Solution #2 | |
|---|---|---|---|---|
| Fann 35 | Stirred | Stirred | Stirred | Stirred |
| RPM | 30 min. | 1 hr. | 30 min. | 1 hr. |
| 600/300 | OS/OS | OS/OS | 311/237 | OS/OS |
| 200/100 | 301/248 | 294/241 | 202/158 | 293/240 |
| 6/3 | 118/100 | 114/94 | 67/55 | 115/96 |
| pH | 7.2 | 7.3 | 7.1 | 7.1 |
| Measured Temp. | 76° F. | 84° F. | 72° F. | 77° F. |

OS = off-scale or too thick to measure

### Example 16

Two solutions were prepared having identical composition. One solution (Solution #3) had 20 ppb of Example No. 2 above added to a 14.2 ppg calcium bromide solution while stirring using an overhead stirrer. This solution contained 17 ppb of 11.3 ppg potassium formate and 3 ppb of HEC 10. The other solution (Solution #4) had 17 ppb of 11.3 ppg potassium formate added to the 14.2 ppg calcium bromide and subsequently, 3 ppb of dry HEC 10. Both solutions having identical compositions were allowed to stir and their thickness measured using a Fann 35 rheometer (B1 bob) at various times. Table VI shows that Solution #3 fully viscosifies within 30 minutes of stirring while Solution #4 shows little change at 3 hours with very little viscosification.

TABLE VI
Viscosification of 14.2 ppg Calcium Bromide Solution

| | Solution #3 | | Solution #4 | | |
|---|---|---|---|---|---|
| Fann 35 | Stirred | Stirred | Stirred | Stirred | Stirred |
| RPM | 30 min. | 1 hr. | 1 hr. | 2 hr. | 3 hr. |
| 600/300 | OS/289 | OS/285 | 12/6 | 23/12 | 32/18 |
| 200/100 | 257/211 | 252/206 | 5/2 | 8/4 | 13/7 |
| 6/3 | 105/86 | 95/78 | <1/<1 | <1/<1 | 1/<1 |
| pH | 4.6 | 4.6 | 4.8 | 4.9 | 4.8 |
| Measured | 71° F. | 75° F. | 70° F. | 71° F. | 68° F. |
| Temp. | | | | | |

Note:
OS = off-scale or too thick to measure

### Example 17

Two solutions were prepared having identical composition. One solution (Solution #5) had 30 ppb of Example No. 13 added to a 15.1 ppg calcium chloride/calcium bromide solution while stirring using an overhead stirrer. The other solution (Solution#6) had 27 ppb of 15.6 ppg cesium formate added to the 15.1 ppg calcium chloride/calcium bromide solution and subsequently, 3 ppb of dry HEC 10. Both solutions having identical compositions were allowed to stir and their thickness measured using a Fann 35 rheometer (B1 bob) at various times. Table VII shows the results noting that Solution #5 fully viscosifies at 1 hour of stirring while Solution #6 shows no viscosification at 2 hours.

TABLE VII
Viscosification of 15.1 ppg Calcium
Chloride/Calcium Bromide Solution

| | Solution #5 | | Solution #6 | |
|---|---|---|---|---|
| Fann 35 | Stirred | Stirred | Stirred | Stirred |
| RPM | 1 hr. | 1.5 hr. | 1 hr.. | 2 hr. |
| 600/300 | OS/OS | OS/OS | 48/24 | 50/25 |
| 200/100 | OS/284 | OS/313 | 16/8 | 17/8 |
| 6/3 | 119/97 | 111/81 | <1/<1 | <1/<1 |
| pH | 6.3 | 6.3 | 6.4 | 6.4 |
| Measured Temp. | 86° F. | 96° F. | 86° F. | 84° F. |

Note:
OS = off-scale or too thick to measure

### Example 18

Two solutions were prepared having identical composition. One solution (Solution #7) had 18.75 ppb of Example No. 7 added to a 19.2 ppg calcium bromide/zinc bromide solution while stirring using an overhead stirrer. This solution contained 15.75 ppb of 11.8 ppg potassium formate and 3 ppb of 210 HHW. The other solution (Solution #8) had 15.75 ppb of 11.8 ppg potassium formate added to the 19.2 ppg calcium bromide/zinc bromide solution and subsequently, 3 ppb of dry 210 HHW. Both solutions having identical compositions were allowed to stir and their thickness measured using a Fann 35 rheometer (B1 bob) at various times. Table VIII shows the results noting that Solution #7 fully viscosifies at 2.5 hours of stirring while Solution #8 shows little change at the same time. Solution #7 was allowed to stir for 24 hours and was still thinner than Solution #3 stirring for 30 minutes.

TABLE VIII
Viscosification of 19.2 ppg Calcium Bromide/Zinc Bromide Solution

| | Solution #7 | | | Solution #8 | | |
|---|---|---|---|---|---|---|
| Fann 35 | Stirred | Stirred | Stirred | Stirred | Stirred | Stirred |
| RPM | 30 min. | 2.5 hr. | 3 hr. | 30 min. | 3 hr. | 24 hr. |
| 600/300 | OS/220 | OS/OS | OS/OS | 68/37 | 110/67 | 202/129 |
| 200/100 | 178/127 | 314/245 | 315/250 | 25/13 | 49/29 | 101/67 |
| 6/3 | 39/31 | 111/91 | 111/90 | 1/<1 | 3/2 | 15/10 |
| pH | 1.8 | 1.9 | 1.9 | 1.8 | 1.8 | 1.8 |
| Measured | 74° F. | 77° F. | 79° F. | 75° F. | 74° F. | 71° F. |
| Temp. | | | | | | |

Note:
OS = off-scale or too thick to measure

### Example 19

Two solutions were prepared having identical composition. One solution (Solution #9) had 42 ppb of Example No. 11 added to a 19.2 ppg calcium bromide/zinc bromide solution while stirring using an overhead stirrer. This solution contained 37.8 ppb of 11.5 ppg potassium formate and 4.2 ppb of CMHEC. The other solution (Solution #10) had 37.8 ppb of 11.5 ppg potassium formate added to the 19.2 ppg calcium bromide/zinc bromide solution and subsequently, 4.2 ppb of dry CMHEC. Both solutions having identical compositions were allowed to stir and their thickness measured using a Fann 35 rheometer (B1 bob) at various times. Table IX shows the results noting that Solution #9 fully viscosifies within 1 hour of stirring while Solution #10 shows little change at the same time.

TABLE IX
Viscosification of 19.2 ppg Calcium Bromide/Zinc Bromide Solution

| | Solution #9 | | | Solution #10 | | |
|---|---|---|---|---|---|---|
| Fann 35 | Stirred | Stirred | Stirred | Stirred | Stirred | Stirred |
| RPM | 15 min. | 30 min. | 1 hr. | 30 min. | 1 hr. | 2 hr. |
| 600/300 | OS/OS | OS/OS | OS/OS | 44/22 | 50/25 | 55/29 |
| 200/100 | OS/312 | OS/OS | OS/OS | 15/7 | 17/8 | 19/10 |
| 6/3 | 139/115 | 145/121 | 147/121 | <1/<1 | <1/<1 | <1/<1 |
| pH | 2.3 | 2.3 | 2.3 | 84° F. | 79° F. | 76° F. |
| Measured | 80° F. | 82° F. | 83° F. | 2.0 | 2.0 | 2.0 |
| Temp. | | | | | | |

Note:
OS = off-scale or too thick to measure

### Example 20

A HEC 10 mixture was prepared adding 1 ppb of CMHPG to a 12.0 ppg KHCO₂ and allowing to stir for 45 minutes. The 300 rpm reading from a Fann 35 for this solution was 37. Then, 18% by weight of HEC 10 was added to 82% by weight of the viscosified 12.0 ppg KHCO₂ solution. Although the HEC 10 is lighter than the potassium formate solution, the addition of CMHPG prevents the HEC 10 from concentrating near the surface (reverse from settling) over time. This mixture is called Mixture No. 15.

Two solutions were prepared having identical composition. One solution (Solution #11) had 16.6 ppb of Mixture No. 15 added to a 13.0 ppg calcium chloride/calcium bromide solution while stirring using an overhead stirrer. The 13.0 ppg was prepared by mixing a 15.1 ppg calcium chloride/calcium bromide solution with an 11.6 ppg calcium chloride solution. The composition by weight is 19.7% calcium bromide, 29.2% calcium chloride and the balance being water. The other solution (Solution #12) had 13.6 ppb of the viscosified 12.0 ppg potassium formate added to the 13.0 ppg calcium chloride/calcium bromide solution and subsequently, 3.0 ppb of dry HEC 10. Both solutions having identical compositions were allowed to stir and their thickness measured using a Fann 35 rheometer (B1 bob) at various times. Table X shows the results with Solution #11 having full viscosification within 1 hour of stirring while the other does not.

TABLE X
Viscosification of 13.0 ppg Calcium Chloride/Calcium Bromide Solution

| | Solution #11 | | Solution #12 | | |
|---|---|---|---|---|---|
| Fann 35 | Stirred | Stirred | Stirred | Stirred | Stirred |
| RPM | 1 hr. | 1.5 hr. | 1 hr. | 1.5 hr. | 2 hr. |
| 600/300 | OS/OS | OS/OS | 37/19 | 40/21 | 43/23 |
| 200/100 | OS/260 | OS/265 | 12/6 | 14/7 | 16/8 |
| 6/3 | 125/106 | 117/95 | <1/<1 | <1/<1 | <1/<1 |
| pH | 6.9 | 7.1 | 7.2 | 7.3 | 7.0 |
| Measured | 81° F. | 85° F. | 76° F. | 75° F. | 76° F. |
| Temp. | | | | | |

Note:
OS = off-scale or too thick to measure

### Example 21

A 14% CMHEC mixture was prepared by weighing 446.2 grams of a 13.1 ppg potassium formate solution, 1 gram of xanthan gum and 132.3 grams of water. The solution was allowed to stir on an overhead stirrer for 20 minutes to allow the xanthan gum to viscosity or thicken the solution. Then another 446.2 grams of 13.1 ppg potassium formate was added and finally 167 grams of CMHEC was added. The final potassium formate density to suspend the CMHEC is 12.2 ppg. Although settling of the CMHEC is impossible, adding xanthan gum as a suspension agent prevented the CMHEC from concentrating at the surface.

To an 11.0 ppg calcium chloride solution, 25 ppb of the CMHEC mixture was added to fully thicken the calcium chloride solution within 30 minutes. The pH of the solution was reduced to 3.5 with fumaric acid and crosslinked with 5 gallons per 1000 gallons of aqueous sodium zirconate solution while stirring. The sodium zirconate serves to crosslink the carboxymethyl group in the CMHEC to form a gel.

From the foregoing, it will be observed that numerous variations and modifications may be effected without departing from the true spirit and scope of the novel concepts of the invention.

1. A cellulosic polymer suspension comprising a cellulosic polymer suspended in a solution, the solution containing from about 40 to about 75 weight percent of an alkali formate, wherein the true crystallization temperature (TCT), API 13 J, of the alkali formate solution is less than or equal to 18° F.

2. The polymer suspension of claim 1, wherein the cellulosic polymer is anionic or non-ionic.

3. The polymer suspension of claim 2, wherein the cellulosic polymer is carboxymethylhydroxyethyl cellulose.

4. The polymer suspension of claim 1, wherein the alkali formate is potassium formate, cesium formate, or a mixture thereof.

5. The polymer suspension of claim 2, wherein the cellulosic polymer is hydroxyethyl cellulose.

6. The polymer suspension of claim 1, wherein the TCT is less than or equal to 0° F.

7. A cellulosic polymer suspension comprising a cellulosic polymer suspended at 70° F. in 40% or more based on total weight of water and salt of alkali formate dissolved in water, wherein the alkali formate is potassium formate or cesium formate or a mixture thereof.

8. The suspension of claim 7, wherein the cellulosic polymer is selected from the group consisting of anionic or nonionic modified cellulose.

9. The suspension of claim 8, wherein the nonionic modified cellulose is hydroxyethylcellulose.

10. The suspension of claim 8, where the anionic modified cellulose is carboxymethyl hydroxyethylcellulose.

11. The suspension of claim 7 where the hydroxyethylcellulose is crosslinked with glycoxal.

12. A cellulosic polymer suspension comprising a cellulosic polymer suspended at 70° F. in between from about 40% to about 75% alkali formate, wherein no more than 25% of the alkali formate is sodium formate, the remainder being potassium formate, cesium formate, or a mixture thereof.

13. The suspension of claim 12, wherein the true crystallization temperature (TCT), API 13J, of the alkali formate solution is less than or equal to 20° F.

14. The suspension of claim 12, where the cellulosic polymer is selected from the group consisting of anionic or nonionic modified cellulose.

15. The suspension of claim 12, where the nonionic modified cellulose is hydroxyethylcellulose.

16. The suspension of claim 12, where the anionic modified cellulose is carboxymethyl hydroxyethylcellulose.

17. The suspension of claim 12, where the hydroxyethylcellulose is crosslinked with glycoxal.

18. A method for thickening a brine during the recovery of oil and/or gas from a subterranean formation which comprises introducing into the formation the cellulosic polymer suspension of claim 1.

19. A method for thickening a brine during the recovery of oil and/or gas from a subterranean formation which comprises introducing into the formation the cellulosic polymer suspension of claim 7.

20. A method for thickening a brine during the recovery of oil and/or gas from a subterranean formation which comprises introducing into the formation the cellulosic polymer suspension of claim 12.

21. The method of claim 18, wherein the brine has a density greater than or equal to 11.6 ppg at 70° F.
